(19) United States
(12) Patent Application Publication
(10) Pub. No.: US 2010/0244678 A1
(43) Pub. Date: Sep. 30, 2010

(54) HOUSING AND MANUFACTURING METHOD THEREOF

(75) Inventors: CHIN-HSIEN LIANG, Shindian (TW); BEN-DING TSAO, Shindian (TW); WEN-LIN XIONG, Shenzhen CitY (CN); DIAN-MING ZHU, Shenzhen City (CN); JIANG-YING HU, Shenzhen City (CN); ZHUN WANG, Shenzhen City (CN); CHONG CAI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/637,906

(22) Filed: Dec. 15, 2009

(30) Foreign Application Priority Data
Mar. 27, 2009 (CN) 200910301195.2

(51) Int. Cl. H01J 1/62; H01J 9/22

(52) U.S. Cl. 313/506; 445/23; 313/512

(57) ABSTRACT

A housing comprises an exterior coating, a contact control coating formed on and bonded with the exterior coating, a light emitting coating formed on and bonded with the contact control coating, and a substrate molded on and bonded with the light emitting coating. The contact control coating and the light emitting coating are defined with electric contacts thereon. A method for manufacturing the housing includes providing a contact control coating; applying a light emitting coating onto the contact control coating; molding a substrate onto the light emitting coating; and defining electric contacts on the contact control coating and the light emitting coating.

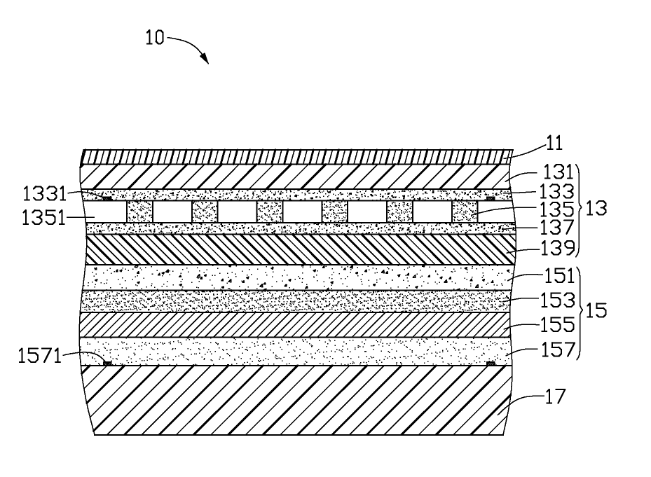

### BACKGROUND

1. Technical Field

The present disclosure relates to housings, especially to a housing having a changeable appearance and a manufacturing method thereof.

2. Description of Related Art

In Molding Label (IML) process is a frequently used method of producing housings for portable electronic devices. The process is carried out by molding a plastic substrate in a mold in combination with a plastic film. Before the substrate is molded, a pattern may be printed on the film, and the molded substrate is bonded with the patterned film, such that, the pattern is protected from damage by being positioned between the film and the substrate. However, the appearance of the housing may not be optimally appealing.

Therefore, there is room for improvement within the art.

### BRIEF DESCRIPTION OF THE FIGURE

Many aspects of the housing can be better understood with reference to the following FIGURE. The components in the figures are not necessarily drawn to scale, the emphasis instead being placed upon clearly illustrating the principles of the housing.

The FIGURE is a cross-section of an exemplary embodiment of a housing.

### DETAILED DESCRIPTION

The FIGURE shows an exemplary housing 10 including an exterior coating 11, a contact control coating 13 bonded with the exterior coating 11, a light emitting coating 15 bonded with the exposed surface of the contact control coating 13, and a substrate 17 bonded with the light emitting coating 15. Coatings 11-15 are applied in sequence onto the interior of a mold and are then transferred to the substrate 17 during a molding process to form the housing 10.

The exterior coating 11 is a transparent plastic coating having a thickness of about 0.05 mm. The exterior coating 11 can undergo surface treatment to smooth its surface once the housing 10 is molded.

The contact control coating 13 includes a first film 131, a first conductive coating 133 bonded with the first film 131, an insulation coating 135 bonded with the exposed surface of the first conductive coating 133, a second conductive coating 137 bonded with the exposed surface of the insulation coating 135, and a second film 139 bonded with the second conductive coating 137.

The first film 131 may be of plastic of a thickness of about 0.075-0.125 mm. The first film 131 is directly bonded with the exterior coating 11.

The first conductive coating 133 may be an oxide indium tin conductive film formed on the first film 131 by printing. The first conductive coating may have a thickness of about 0.25-0.35 μm, and in this exemplary embodiment about 0.3 μm. The first conductive coating 133 is defined with electric contacts 1331 thereon.

The insulation coating 135 is an ink coating formed between the first conductive coating 133 and the second conductive coating 137. The insulation coating 135 is a discontinuous coating. A plurality of cavities 1351 arranged in a matrix are defined in the insulation coating 135. The thickness of the insulation coating 135 may be about 4.5-5.5 μm, and in this exemplary embodiment about 5.0 μm. The insulation coating 135 can insulate the first conductive coating 133 from the second conductive coating 137.

The second conductive coating 137 may be an oxide indium tin conductive film formed by printing of a thickness of about 0.25-0.35 μm, and in this exemplary embodiment about 0.3 μm.

The second film 139 may be of plastic of a thickness of about 0.125 mm.

The light emitting coating 15 includes a third conductive coating 151, a light emitting medium coating 153 bonded with the third conductive coating 151, a intermediate coating 155 bonded with the light emitting medium coating 153, and a fourth conductive coating 157 bonded with the intermediate coating 155.

The third conductive coating 151 may be an oxide indium tin conductive film formed on the exposed surface of the second film 139 by printing. The third conductive coating 151 may have a thickness of about 7.25-8.5 μm, and in this exemplary embodiment about 8 μm.

The light emitting medium coating 153 is formed on the exposed surface of the third conductive coating 151 by printing. The material contained in the light emitting medium coating 153 is mainly zinc sulfide particles electroluminescent material. The light emitting medium coating 153 may have a thickness of about 30 μm.

The intermediate coating 155 is formed on an exposed surface of the light emitting medium coating 153 by printing. The material contained in the intermediate coating 155 is mainly a solid-slurry of barium titanate. The intermediate coating 155 may have a thickness of about 15 μm. The intermediate coating 155 can insulate the light emitting medium coating 153 from the fourth conductive coating 157.

The fourth conductive coating 157 may be a solidified electric silver paste coating formed on the exposed surface of the intermediate coating 155 by printing. The material contained in the fourth conductive coating 157 is mainly silver powder and binding. The thickness of the fourth conductive coating 157 is about 8 μm. The fourth conductive coating 157 is defined with electric contacts 1571 thereon.

The substrate 17 is a plastic coating formed on an exposed surface of the fourth conductive coating 157 by molding.

The electric contacts 1331 of the first conductive coating 133 and the electric contacts 1571 of the fourth conductive coating 157 can electrically connect with an electronic device (e.g., mobile phone, PDA etc.) when the housing 10 is fixed on the electronic device. Thus, external spot pressure on the exterior coating 11 generates contact between the first conductive coating 133 and the second conductive coating 137 to produce a potential difference. The potential difference is then transferred to an A/D controller of the electronic device to generate a control command to illuminate the light emitting coating 15 which can be observed through the exterior coating 11. When the pressure stops, the light stops. As such, a housing 10 having a changeable appearance is obtained.

A method for manufacturing the housing 10, in this exemplary embodiment, includes: manufacturing a contact control coating; manufacturing a light emitting coating onto the contact control coating; molding a substrate onto the light emitting coating; and defining electric contacts on the contact control coating and the light emitting coating.

Referring to the FIGURE, an exterior coating 11 is provided. The exterior coating 11 is of plastic.

A contact control coating 13 may be manufactured as follows:

A first film 131 is provided, of plastic of a thickness of about 0.075-0.125 mm.

A first conductive coating 133 is printed on the first film 131. The first conductive coating 133 may be an oxide indium tin conductive film of a thickness of about 0.25-0.35 μm, and in this exemplary embodiment about 0.3 μm.

An insulation coating 135 is applied onto the exposed surface of the first conductive coating 133. The insulation coating 135 may be formed by printing an insulating ink coating on the first conductive coating 133; and then etching a portion of regions of the insulating ink coating by inorganic acid, such as dilute hydrochloric acid and dilute nitric acid, or inorganic alkali, such as sodium hydroxide solution and soda water to form the insulation coating 135. The preserved regions of the insulating ink coating are shielded by a film during etching. The insulation coating 135 may have a thickness of about 4.5-5.5 μm, and in this exemplary embodiment about 5.0 μm.

A second film 139 is provided. The second film 139 is of plastic of a thickness of about 0.125 mm.

A second conductive coating 137 is printed on the second film 139. The second conductive coating 137 may be an oxide indium tin conductive film of a thickness of about 0.25-0.35 μm, and in this exemplary embodiment about 0.3 μm.

The second film 139 with the second conductive coating 137 and the first film 131 with the first conductive coating 133 and the insulation coating 135 are then laminated together to form the contact control coating 13, with the second conductive coating 137 directly bonded with the insulation coating 135.

After the contact control coating 13 being formed, the contact control coating 13 and the exterior coating 11 are laminated together with the first film 131 directly bonded with the exterior coating 11.

A light emitting coating 15 may be manufactured as follows:

A third conductive coating 151 is printed on the exposed surface of the second film 139. The third conductive coating 151 may be an oxide indium tin conductive film of a thickness of about 7.25-8.5 μm, and in this exemplary embodiment about 8 μm.

A light emitting medium coating 153 is printed on the third conductive coating 151. The material contained in the light emitting medium coating 153 is mainly zinc sulfide particles electroluminescent material.

A intermediate coating 155 is printed on the light emitting medium coating 153. The material contained in the intermediate coating 155 is mainly a solid-slurry of barium titanate.

A fourth conductive coating 157 is printed on the intermediate coating 155 to provide light emitting coating 15. The fourth conductive coating 157 may be a solidified electric silver paste coating. The material contained in the fourth conductive coating 157 is mainly silver powder and binding.

After the light emitting coating 15 is manufactured, the exterior coating 11, the contact control coating 13 and the light emitting coating 15 become integral and in sequence are formed the shape of the housing 10 in a mold.

A substrate 17 is then molded onto the fourth conductive coating 157 to produce the final housing 10.

After the housing 10 is formed, the first conductive coating 133 of the contact control coating 13 is defined with electronic contacts 1331 thereon and the fourth conductive coating 157 of the light emitting coating 15 is defined with electronic contacts 1571 thereon.

The exemplary housing 10 may be a housing of a mobile phone, a PDA, a camera, or a portable game device.

It should be understood, however, that even though numerous characteristics and advantages of the present embodiments have been set forth in the foregoing description, together with details of functions of the embodiments, the disclosure is illustrative only, and changes may be made in detail within the principles of the disclosure to the full extent indicated by the broad general meaning of the terms in which the appended claims are expressed.

What is claimed is:

1. A housing, comprising:
an exterior coating;
a contact control coating formed on and bonded with the exterior coating, the contact control coating defined with electric contacts thereon;
a light emitting coating formed on and bonded with the contact control coating, the light emitting coating defined with electric contacts thereon; and
a substrate molded on and bonded with the light emitting coating.

2. The housing as claimed in claim 1, wherein the contact control coating includes a first film, a first conductive coating bonded with the first film, an insulation coating bonded with the first conductive coating, a second conductive coating bonded with the insulation coating, and a second film bonded with the second conductive coating.

3. The housing as claimed in claim 2, wherein the first conductive coating is defined with electric contacts thereon.

4. The housing as claimed in claim 2, wherein the first conductive coating and the second conductive coating are oxide indium tin conductive film and both coatings have a thickness of about 0.25-0.35 μm.

5. The housing as claimed in claim 2, wherein the insulation coating is set between the first conductive coating and the second conductive coating and has a thickness of about 4.5-5.5 μm.

6. The housing as claimed in claim 2, wherein the light emitting coating includes a third conductive coating, a light emitting medium coating bonded with the third conductive coating, an intermediate coating bonded with the light emitting medium coating, and a fourth conductive coating bonded with the intermediate coating.

7. The housing as claimed in claim 6, wherein the third conductive coating is an oxide indium tin conductive coating having a thickness of about 7.25-8.5 μm.

8. The housing as claimed in claim 6, wherein the light emitting medium coating contains zinc sulfide particles and has a thickness of about 30 μm.

9. The housing as claimed in claim 6, wherein the intermediate coating contains barium titanate of a thickness of about 15 μm.

10. The housing as claimed in claim 6, wherein the fourth conductive coating is a solidified electric silver paste coating and has a thickness of about 8 μm.

11. The housing as claimed in claim 6, wherein the fourth conductive coating includes electric contacts.

12. A method for manufacturing a housing, including:
providing a contact control coating;
applying a light emitting coating onto the contact control coating;
molding a substrate onto the light emitting coating; and
defining electric contacts on the contact control coating and the light emitting coating.

13. The method as claimed in claim 12, wherein providing the contact control coating includes providing a first film and printing a first conductive coating on the first film; applying an insulation coating onto the first conductive coating; providing a second film and printing a second conductive coating on the second film; laminating the first film with the insulation coating and the second film with the second conductive coating to form the contact control coating and with the insulation coating bonded with the second conductive coating.

14. The method as claimed in claim 13, wherein the insulation coating is made by printing an insulating ink coating on the first conductive coating; and etching a portion of regions of the insulating ink coating.

15. The method as claimed in claim 13, wherein the light emitting coating is made by printing a third conductive coating on the exposed surface of the second film; printing a light emitting medium coating on the third conductive coating; printing a intermediate coating on the light emitting medium coating, and printing a fourth conductive coating on the intermediate coating.

16. The method as claimed in claim 13, wherein the first film of the contact control coating is laminated with a exterior coating after the contact control coating is provided, the exterior coating is of plastic.

17. The method as claimed in claim 15, wherein the electric contacts is defined on the first conductive coating of the contact control coating and the fourth conductive coating of the light emitting coating.
